(19) United States
(12) Patent Application Publication
(10) Pub. No.: US 2011/0196108 A1
(43) Pub. Date: Aug. 11, 2011

(54) Gel Point Modification In Alkyd Resin Manufacture

(76) Inventors: Isao Noda, Fairfield, OH (US); William M. Allen, JR., Liberty Twsp., OH (US)

(21) Appl. No.: 13/020,478

(22) Filed: Feb. 3, 2011

Related U.S. Application Data
(60) Provisional application No. 61/302,076, filed on Feb. 5, 2010.

(51) Int. Cl. C08G 63/91

(52) U.S. Cl. 525/418

(57) ABSTRACT

Disclosed herein is a metastable, liquid alkyd resin precursor that has exceeded its gel point, but is not a gel. The precursor includes a gel point modifier and a prepolymer liquid. The prepolymer liquid includes oligomeric polyesters, polyols, and an excipient selected from the group consisting of polyfunctional acids, anhydrides, and mixtures thereof. Also disclosed herein are methods of making the metastable, liquid alkyd resin precursor, and methods of using the metastable, liquid alkyd resin precursor to form fully cross-linked alkyd resins.

### CROSS REFERENCE TO RELATED APPLICATION

This application claims the benefit of U.S. Provisional Application No. 61/302,076 filed Feb. 5, 2010.

### FIELD OF THE INVENTION

This disclosure relates to a metastable, liquid alkyd material that has exceeded its gel point but is not a gel, methods of making the liquid alkyd material, and uses thereof.

### BACKGROUND OF THE INVENTION

Alkyd resins are polymer networks comprised of ester cross-links that are formed by the condensation of polyols with polyfunctional acids, anhydrides, or a mixture of polyfunctional acids and anhydrides. Upon curing, alkyd resins exhibit properties characteristic of thermoset resins.

Thermoset resins are high molecular weight polymers that irreversibly convert into infusible (i.e. incapable of being melted) and insoluble (i.e. cannot be dissolved in a solvent) polymer networks by curing. Curing refers to the toughening or hardening of a polymer material by the cross-linking of polymer chains. “Cross-linking” is the process of bonding one polymer chain to another. Prior to curing, thermoset materials are typically liquid or malleable, and exist as a reactive mixture of monomers and oligomers. This reactive mixture is introduced into a mold where it is cross-linked to create a rigid, three-dimensional network of oligomer chains with a desired shape or form.

The formation of alkyd resins occurs in three stages that are schematically depicted in the sole drawing. During Stage I, a polyol and an excipient selected from the group consisting of a polyfunctional acid, an anhydride, or mixtures thereof, is heated to promote rapid esterification of the polyol and excipient monomers. As a result of this condensation reaction, a water by-product is violently liberated from the reaction mixture. Stage I ends when at least about 50% of the polyol and the excipient monomers have undergone condensation (a) to result in the formation of a prepolymer liquid comprising oligomeric polyesters, polyols, and the excipient. This prepolymer liquid is free-flowing at an elevated temperature with a low viscosity, demonstrating that it is not extensively cross-linked During Stage II (b), condensation of the monomers and oligomers in the prepolymer liquid continues, but at a significantly slower rate than during Stage I. The molecular weight and viscosity of the prepolymer liquid increases during this stage of alkyd resin formation, although the liberation rate of the water by-product decreases significantly and is easily controlled. After at least about 70% to about 80% of the polyol and excipient have undergone condensation, depending on the specific polyol and excipient used, the prepolymer material congeals into a solid mass. This congealment is termed the “gel point” of the condensation (c). At the gel point, a three-dimensional network that is swollen with prepolymers is formed, with most of the prepolymer molecules not yet cross-linked Beyond the gel point, the alkyd material is insoluble and infusible, even at an elevated temperature, and the shape of the material is set. During Stage III of alkyd resin formation, additional condensation of the oligomers and monomers occurs until the gel is fully cross-linked and exhibits properties that are characteristic of thermoset resins (d). This resin is infusible and does not swell in the presence of solvents.

The gel point of alkyd resins is a useful indicator of the onset of the formation of a cross-linked thermoset resin with good structural integrity and dimensional stability. Several useful models have been proposed to predict the gel point of a condensation reaction involving polyfunctional monomers. The simplest and oldest model is “Gel Theory” proposed by Carrothers (W. H. Carrothers, Trans. Faraday Soc. 32, 39 (1936)). According to Carrothers' theory, the degree of conversion of monomer to oligomer at the gel point (p_{gei}) can be estimated by Formula I:

$${p}_{gel} = \frac{2}{{f}_{average}} \qquad Formula I$$

wherein f_{average} (i.e. the average functionality of a reaction mixture) is the sum of (i) the number of alcohol moieties on the polyol, (ii) the number of acid moieties on the polyfunctional acid, and (iii) twice the number of anhydride moieties on the anhydride, divided by the total number of polyols, polyfunctional acids, and anhydrides.

Although the Carrothers' model is a good predictor of the degree of conversion of monomer to oligomer at the gel point, it often overestimates the gel point by about 5% to about 10% because it neglects important factors such as the effect of temperature and other thermodynamic parameters. Adding a heuristic correction factor (k) as shown in Formula II, wherein k is about 0.9 to about 1, allows a closer estimation of the actual onset of gelation:

$${p}_{gel ( corrected )} = \frac{2 ( k )}{{f}_{average}} \qquad Formula II$$

wherein f_{average} is as defined above. Therefore, according to Carrothers' theory, the higher the number of functional groups on an individual monomers, the lower the degree of monomer conversion at the corrected, theoretical gel point, p_{gel(corrected)}.

Table 1 illustrates the percent conversion of monomer to oligomer at the corrected, theoretical gel point p_{gel(corrected)} of alkyd resin formation as a function of the sum of functional groups on polyol and polyfunctional acid monomers using Carrothers' theory (Formula II), a k of 0.95, and assuming a 1:1 ratio of polyol monomer to polyfunctional acid monomer. For example, monomers with a total of five functional groups will reach the gel point after about 76% conversion, while monomers with a total of 12 functional groups will reach the gel point after only about 32% conversion.

TABLE 1
Effect of the sum of monomer functional groups on the % monomer
conversion at the corrected, theoretical gel point, p_{gel(corrected)}.

| | | Total Number | |
|---|---|---|---|
| Number of | Number of | of Functional | % Conversion |
| —OH on | —COOH | Groups | at |
| Polyol Monomer | on Acid Monomer | (f_{average}) | the Gel Point |
| 2 | 2 | 4 | 95%* |
| 3 | 2 | 5 | 76% |
| 3 | 3 | 6 | 63% |
| 2 | 10 | 12 | 32% |
| 2 | 100 | 102 | 3.7% |

*Bifunctional monomers theoretically form linear polymers. Without being bound by any particular theory, in practice, some degree of cross-linking occurs between bifunctional monomers due to side reactions.

Table 2 illustrates the number of functional groups present on monomer starting materials that are commonly used to form alkyd resins.

TABLE 2
Reactive functionalities of alkyd resin monomers

| Monomer | Number of Functional Groups |
|---|---|
| Glycerol | 3 |
| 1,3-Propanediol | 2 |
| Adipic acid | 2 |
| Maleic anhydride | 2 |
| Succinic anhydride | 2 |
| Phthalic anhydride | 2 |
| Citric acid | 3 |
| Monofunctional fatty acid | 1 |
| Poly(acrylic acid) | >>100 |
| Poly(vinyl alcohol) | >>100 |

Because the average functionality of a reaction mixture, f_{average}, is the weighted sum of the individual reactive functionalities, the corrected, theoretical gel points of representative alkyd resin condensation reactions can be estimated from Formula II, wherein k=0.95, as shown in Table 3.

TABLE 3
Gel points of alkyd condensation reaction mixtures estimated by
Formula II.

| | | Estimated |
|---|---|---|
| | | gel point, |
| Reaction Mixture | f_{average} | p_{gel(corrected)} |
| Glycerol + Phthalic anhydride (1:1) | 2.5 | 0.76 |
| Glycerol + Adipic acid (1:1) | 2.5 | 0.76 |
| Glycerol + Adipic Acid (5:1) | 2.83 | 0.67 |
| Glycerol + Succinic Anhydride (1:1) | 2.5 | 0.76 |
| Glycerol + Maleic Anhydride (1:1) | 2.5 | 0.76 |
| Glycerol + Maleic Anhydride (1:2) | 2.33 | 0.82 |
| Glycerol + Maleic Anhydride (2:1) | 2.67 | 0.71 |
| Glycerol + Citric Acid (1:1) | 3 | 0.63 |
| Glycerol + Citric Acid + Stearic Acid (1:1:1) | 2.33 | 0.82 |
| Glycerol + Adipic Acid + Stearic Acid (1:1:1) | 2 | 0.95 |
| Glycerol + Poly(acrylic acid) (1:1) | >100 | <0.01 |
| Glycerol + Poly(acrylic acid) (50:1) | >10 | <0.1 |

The degree of monomer conversion in an alkyd resin and the time required for processing the alkyd resin can be manipulated by the types of polyfunctional monomers that are used. For example, if monomers with a low number of functional groups are used, the resulting alkyd resin will have a high degree of conversion but will take more time to progress through Stage II, increasing the manufacture time of the alkyd resin. Because the gel point is reached more slowly, the alkyd resin material will need prolonged heating in a mold before becoming cured and obtaining properties that are characteristic of a thermoset resin. Prolonged heating in a mold introduces undesirable effects such as the formation of bubbles and other defects in the final product due to the liberation of water vapor during condensation. If monomers with a high number of functional groups are used, the alkyd resin process will take less time to progress through Stage II, decreasing the manufacture time. However, the resulting alkyd resin will have a lower degree of conversion. Because a lower degree of conversion is achieved at the gel point, the material will need additional post-curing to become an alkyd material with properties that are characteristic of a thermoset resin. An ideal system for practical applications of alkyd resins would include the highest possible ester conversion to minimize the requirement for additional curing after gelation, and the shortest amount of processing time. However, it is currently not possible to produce alkyd resins with a high degree of conversion in a shortened amount of time.

The gel point of alkyd resins can also be used as a point of reference for forming different types of alkyd materials. Essentially three types of materials exist in the alkyd resin industry, each formed by one of two different, one-step approaches. In the first approach, condensation of monomers is allowed to occur up to but not exceeding the gel point of the material, at which point the condensation reaction is arrested. The resulting material, which has undergone about 60% to about 70% conversion is still prepolymer and is used in the paint industry. The majority of the cross-linking present in paints is due to the radical polymerization of residual double bonds instead of a network of ester linkages.

In the second approach, the condensation of monomers is allowed to occur until the prepolymer material has exceeded its gel point to form a solid, cross-linked network. The resulting material has properties that are characteristic of thermoset resins. Coatings and enamels are examples of alkyd materials that are formed using this second approach. However, enamels are applied to a surface while in the prepolymer stage and then subjected to additional heating until the gel point has been exceeded. Therefore alkyd resin materials in the art have either not reached their gel points and exist as prepolymer, or have exceeded their gel points and exist as cross-linked, materials with properties that are characteristic of thermoset resins.

### SUMMARY OF THE INVENTION

Disclosed herein is a metastable, liquid alkyd resin precursor that has exceeded its gel point but is not a gel. The precursor includes a gel point modifier and a prepolymer liquid. The prepolymer liquid includes oligomeric polyesters, polyols, and an excipient selected from the group consisting of polyfunctional acids, anhydrides, and mixtures thereof. The prepolymer liquid has reached about 50% to about 90% of its corrected, theoretical gel point, p_{gel(corrected)}. The corrected, theoretical gel point is determined by Formula II:

$${p}_{gel ( corrected )} = \frac{2 ( k )}{{f}_{average}} , \qquad Formula II$$

wherein k is about 0.9 to about 1, and f_{average} is the sum of (i) the number of alcohol moieties on the polyol, (ii) the number of acid moieties on the polyfunctional acid, and (iii) twice the number of anhydride moieties on the anhydride, divided by the total number of polyols, polyfunctional acids, and anhydrides.

Another aspect of the invention is a method of preparing a metastable, liquid alkyd resin precursor. In this method, a gel point modifier is added to prepolymer liquid that has reached at least about 50% of its corrected, theoretical gel point to form the liquid alkyd resin precursor. The prepolymer liquid includes oligomeric polyesters, polyols, and an excipient selected from the group consisting of polyfunctional acids, anhydrides, and mixtures thereof.

In yet another aspect, the invention relates to a method of preparing a fully cross-linked alkyd resin. In this method, a gel point modifier is added to the prepolymer liquid, generally described in the preceding paragraph, to form a liquid alkyd resin precursor. The precursor is then heated while concurrently removing water that has been generated as a by-product of the condensation reaction to form the fully cross-linked alkyd resin.

Additional features of the invention may become apparent to those skilled in the art from a review of the following detailed description, taken in conjunction with the drawing, the examples, and the appended claims.

### BRIEF DESCRIPTION OF THE DRAWINGS

The sole drawing is a schematic representation of the conversion stages of alkyd resin formation.

### DETAILED DESCRIPTION OF THE INVENTION

It has now been found that the gel point of an alkyd resin can be manipulated to form a new type of alkyd material. As previously described, alkyd materials currently exist in one of two forms: (i) a prepolymer liquid that has not reached its gel point (e.g. paint), or (ii) a cross-linked, resin that has exceeded its gel point with properties characteristic of a thermoset resin (e.g. enamel). Unlike the currently known alkyd materials, the novel alkyd material of the invention is a metastable, liquid alkyd resin precursor that has exceeded its gel point but is not a gel. Because this material has already exceeded its gel point, it will solidify into a fully cured alkyd resin almost immediately after heating with the concurrent removal of water.

It has also been found, quite surprisingly, that it is possible to manipulate the gel point of an alkyd material through the use of a gel point modifier to obtain an alkyd resin with a high degree of monomer conversion in a decreased amount of time. Often, the onset of gelation in an alkyd material is difficult to predict or control, which makes the processing of these materials difficult. The higher the number of functional groups on the monomers used for alkyd resin formation, the more difficult it is to control the onset of gelation. Unexpectedly, control over the onset of gelation can be obtained by adding a gel point modifier to an alkyd prepolymer liquid, even though the gel point modifier is itself highly functionalized.

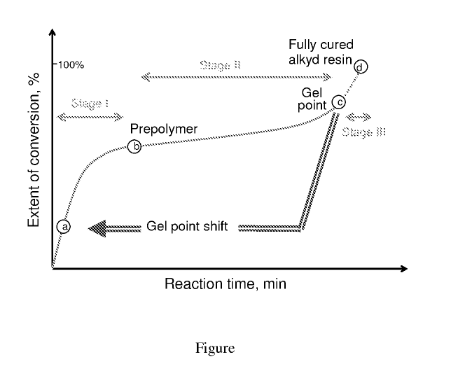

This novel, metastable, liquid alkyd resin precursor and novel method of manufacturing alkyd resins are enabled by the timed addition of a highly functional monomer to the prepolymer liquid that forms during Stage II of alkyd resin processing. In short, monomers having a low number of functional groups are subjected to Stage I and part of Stage II of alkyd resin formation (FIG. 1). These monomers undergo condensation until they achieve a high degree of monomer conversion, which is possible due to the low number of functional groups on the monomers. Once the prepolymer liquid attains a high degree of monomer conversion but before it reaches its gel point (between points (b) and (c) of the sole drawing), the condensation reaction is arrested and a highly functional monomer is added. This highly functional monomer, termed a “gel point modifier,” effectively shifts the gel point of the alkyd material to a percent conversion that is lower than the degree of conversion that has already been achieved (point (a) of the sole drawing). The result is a liquid, alkyd resin precursor that has exceeded its gel point, but is not a gel. This liquid, alkyd resin precursor is metastable and can be stored and shipped at temperatures of up to about 100° C. This metastable precursor can subsequently be gelled at will into a fully cross-linked alkyd resin of any desired shape with good dimensional stability and mechanical integrity through the addition of heat and the removal of water.

For example, a polyol comprising three alcohol moieties can undergo condensation with an excipient comprising two acid moieties. The corrected, theoretical gel point of this system occurs at 76% conversion (Table 1). However, if the condensation reaction is stopped before the prepolymer liquid reaches its gel point (e.g. at about 70% conversion) and a gel point modifier having 10 functional groups is added to the prepolymer liquid, the corrected, theoretical gel point shifts to, for example, about 10% conversion, depending on the amount of gel point modifier added. The prepolymer liquid is already at, for example 70% conversion, but the corrected, theoretical gel point is now at, for example, 10% conversion. Therefore, a metastable, liquid, alkyd material results that has exceeded its gel point but is not a gel. Further condensation of the metastable material does not occur to form a gel unless the precursor is heated with the concurrent removal of water.

Alkyd resins are specifically suited to the novel methods and materials of this invention because they are unique from other types of resins (e.g. epoxy resins). Alkyd resins are comprised of ester cross-links that form from the condensation of a polyol with an excipient. Because the condensation reaction can be stopped at any point by, for example cooling the reaction or discontinuing the removal of water, and then restarted by heating the reaction and removing water, alkyd resins are able to form a non-gel system that is ready to be cross-linked at will. The formation of other types of thermoset resins cannot be stopped and then restarted in the same way.

In one aspect, the invention relates to a metastable, liquid, alkyd resin precursor material that has theoretically exceeded its gel point but is not a gel. The liquid alkyd resin precursor includes a gel point modifier and a prepolymer liquid. The prepolymer liquid includes oligomeric polyesters, polyols, and an excipient selected from the group consisting of polyfunctional acids, anhydrides, and mixtures thereof. The monomers of the prepolymer liquid have preferably undergone about 40% to about 80%% conversion, more preferably about 70% to about 75% conversion, resulting in a liquid alkyd resin precursor that has preferably reached about 50% to about 90%, more preferably about 80% to about 85% of its corrected, theoretical gel point, p_{gel(corrected)}, as determined by Formula II

$${p}_{gel ( corrected )} = \frac{2 ( k )}{{f}_{average}} \qquad Formula II$$

wherein f_{average} is the sum of (i) the number of alcohol moieties on the polyol, (ii) the number of acid moieties on the polyfunctional acid, and (iii) twice the number of anhydride moieties on the anhydride, divided by the total number of polyols, polyfunctional acids, and anhydrides; and k is preferably about 0.9 to about 1, more preferably about 0.95. The viscosity of the liquid alkyd resin precursor is about 0.1 kg m⁻¹s⁻¹ to about 10,000 kg m⁻¹s⁻¹ at about 160° C. to about 220° C.

The gel point modifier of the alkyd resin precursor is a molecule that has at least three, preferably at least four functional groups selected from the group consisting of acids, alcohols, amines, thiols, epoxides, anhydrides, and mixtures thereof. The gel point modifier is preferably present in a concentration of about 0.1 wt. % to about 10 wt. %, more preferably about 0.5 wt. % to about 5 wt. %, even more preferably about 1 wt. %, based on the total weight of the precursor. The gel point modifier can be an alcohol having primary hydroxyl groups or a polyfunctional acid, the alcohol or acid having at least four functional groups. Nonlimiting examples of the polyol or polyfunctional acid gel point modifier include glycerol, pentaerythritol, dipentaerythritol, trimethylolpropane, trimethylolethane, polyglycerol, diglycerol, triglycerol, hexanetriol, erythritol, xylitol, maltitol, mannitol, polyvinyl alcohol, succinic acid, trimellitic anhydride, polyacrylic acid, polymethacrylic acid, and mixtures thereof. In some embodiments, the gel point modifier is selected from the group consisting of pentaerythritol, trimethylolpropane, trimethylolethane, polyacrylic acid, and mixtures thereof.

The gel point modifier of the alkyd resin precursor can also be a derivatized fatty acid, fat or oil, such as monoglycerides, diglycerides, triglycerides, or mixtures thereof. A “derivatized” fatty acid, fat, or oil is a fatty acid, fat, or oil having pendant alcohol, epoxide, carboxylic acid, or anhydride groups. “Fatty acid” refers to a straight chain monocarboxylic acid having a chain length of 12 to 30 carbon atoms. “Monoglycerides,” “diglycerides,” and “triglycerides” refer to mono-, di- and tri-esters, respectively, of (i) glycerol and (ii) the same or mixed fatty acids containing multiple unsaturated double bonds. These fatty acids, fats, or oils can be derivatized to form highly effective, multifunctional gel modifiers capable of reacting with either alcohol or carboxylic acid moieties. The use of derivatized fatty acids, fats, or oils as gel point modifiers is highly advantageous because these compounds are able to undergo quick reactions without producing a water by-product and allow flexibility in formulating materials with different properties.

Typical fatty acid, fat, monoglyceride, diglyceride, and triglyceride oils that are useful herein have been derivatized to contain pendant carboxylic acid, anhydride, epoxide, or alcohol groups. Nonlimiting examples of fatty acid gel point modifiers include derivatized oleic acid, myristoleic acid, palmitoleic acid, sapienic acid linoleic acid, linolenic acid, arachidonic acid, eicosapentaenoic acid, and docosahexaenoic acid. In some embodiments, the fatty acid that is derivatized preferably is selected from the group consisting of oleic acid, linoleic acid, linolenic acid, and arachidonic acid. Examples of fat gel point modifiers include derivatized animal fat. Nonlimiting examples of monoglyceride oil gel point modifiers include monoglycerides of any of the derivatized fatty acids described herein. Nonlimiting examples of diglyceride oil gel point modifiers include diglycerides of any of the derivatized fatty acids described herein. Nonlimiting examples of the triglyceride oil gel point modifier include triglycerides of any of the derivatized fatty acids described herein. For example, the triglyceride gel point modifier is selected from the group consisting of derivatized: tall oil, corn oil, soybean oil, sunflower oil, safflower oil, linseed oil, perilla oil, cotton seed oil, tung oil, peanut oil, oiticica oil, hempseed oil, marine oil (e.g. alkali-refined fish oil), dehydrated castor oil, and mixtures thereof. In some embodiments, the triglyceride oil that is derivatized preferably is tall oil, corn oil, soybean oil, sunflower oil, safflower oil, perilla oil, cotton seed oil, peanut oil, oiticica oil, hempseed oil, marine oil (e.g. alkali-refined fish oil), and dehydrated castor oil, and more preferably is soybean oil. The fatty acid, fat, or oil gel point modifier preferably has been derivatized to include two to four pendant carboxylic acid, anhydride, epoxide or alcohol groups. A derivatized fatty acid, fat, or oil gel point modifier with more than four pendant groups is too reactive, and a fatty acid, fat, or oil gel point modifier with less than two pendant groups is not capable of cross-linking.

The fatty acid, fat, or oil gel point modifier can result from the derivatization of fatty acid chains containing double bonds with unsaturated dicarboxylic acids or anhydrides to form pendant carboxylic acid or anhydride groups. These pendant carboxylic acid and anhydride groups are able to react with alcohol moieties. Nonlimiting examples of dicarboxylic acids and anhydrides that can be used to derivatize fatty acids, fats, or oils include maleic acid, fumaric acid, citraconic acid, itaconic acid, maleic anhydride, citraconic anhydride, and itaconic anhydride. Unsaturated dicarboxylic acids and anhydrides that are too sterically hindered at or near the point of unsaturation (i.e. dimethylmaleic anhydride) are not useful herein and may be easily determined by one skilled in the art. The unsaturated dicarboxylic acid preferably is maleic acid or maleic anhydride, and is more preferably maleic anhydride. Maleated triglyceride oils are commericially available and are inexpensive. For example, maleated soybean oil is commercially available under the tradename CERAPHYL NGA (CAS# 68648-66-8) from International Specialty Products Inc. (ISP; Lombard, Ill.). Maleated fatty acids, fats, and oils can also be synthesized from a suitable fatty acid, fat, or oil and maleic acid or maleic anhydride (or another suitable unsaturated dicarboxylic acid or anhydride as described herein) by thermal condensation in an “Ene” or “Diels-Alder” adduction.

The fatty acid, fat, or oil gel point modifier can result from epoxidation of fatty acid chains containing double bonds to form pendant alcohol groups. These pendant alcohol groups are able to react with carboxylic acid moieties. Nonlimiting examples of epoxidation reagents include peroxy acids (i.e an oxidizing agents having the chemical formula RCO₃H) such as m-chloroperoxybenzoic acid (mCPBA), perbenzoic acid, and peracetic acid, peroxydisulfuric acid, peroxymonosulfuric acid, and hydrogen peroxide. The epoxidation reagent is preferably a peroxy acid and is more preferably mCPBA. Epoxidized oils are commericially available and are inexpensive. For example, epoxidized soybean oil is commercially available under the tradename VIKOFLEX 7170 (CAS# 8013-07-08) from Arkema (Philadelphia, Pa.). Procedures for preparing epoxidized fatty acids, fats, or oils are described in “Advanced Organic Chemistry”, 6th Ed. by J. March, McGraw-Hill Book Company, 2007, p. 1169-1179.

The prepolymer liquid of the alkyd resin precursor includes a polyol, an excipient selected from the group consisting of a polyfunctional acid, an anhydride, and mixtures thereof, and oligomers formed by the condensation of the polyol with the excipient. When the excipient is a polyfunctional acid, the molar ratio of total acid moieties on the polyfunctional acid to alcohol moieties on the polyol preferably is about 10:1 to about 1:10, more preferably about 3:1 to about 1:3, and even more preferably about 1:1. When the excipient is an anhydride, the molar ratio of total anhydride moieties on the anhydride to total alcohol moieties on the polyol preferably is about 5:1 to about 1:5, preferably about 1.5:1 to about 1:1.5, even more preferably about 0.5:1.

The polyol of the prepolymer liquid preferably is a molecule that includes at least two alcohol moieties, preferably at least three alcohol moieties. Preferably, the alcohol moieties are primary hydroxyl groups. Nonlimiting examples of polyols include glycerol, 1,3-propanediol, pentaerythritol, dipentaerythritol, trimethylolpropane, trimethylolethane, ethylene glycol, diethylene glycol, polyglycerol, diglycerol, triglycerol, 1,2-propanediol, 1,4-butanediol, neopentylglycol, hexanediol, hexanetriol, erythritol, xylitol, maltitol, mannitol, polyvinyl alcohol, and mixtures thereof. In some specific embodiments, the polyol is selected from the group consisting of glycerol, pentaerythritol, trimethylolpropane, trimethylolethane, and mixtures thereof.

The excipient of the prepolymer liquid is selected from the group consisting of a polyfunctional acid, an anhydride, and mixtures thereof. The polyfunctional acid preferably is a molecule that includes at least two carboxylic acid moieties, more preferably at least three carboxylic acid moieties. The anhydride preferably is a molecule that includes at least one anhydride moiety. Nonlimiting examples of the excipient include adipic acid, maleic acid, succinic acid, sebacic acid, suberic acid, fumaric acid, glutaric acid, phthalic acid, malonic acid, isophthalic acid, terephthalic acid, azelaic acid, dimethylolpropionic acid, maleic anhydride, succinic anhydride, phthalic anhydride, trimellitic anhydride, polyacrylic acid, polymethacrylic acid, and mixtures thereof. In some specific embodiments, the excipient is an anhydride selected from the group consisting of maleic anhydride, succinic anhydride, phthalic anhydride, and mixtures thereof.

The metastable, liquid, alkyd resin precursor of the invention is the first demonstration of an alkyd material that has surpassed its theoretical gel point, but is not actually a gel. Advantageously, this material can be stored indefinitely and shipped at temperatures up to about 100° C. The material can also be gelled at will with the addition of heat and the concurrent removal of water, which is liberated as a by-product of the condensation reaction, to result in a fully cured alkyd resin product. When the liquid alkyd resin precursor material is ultimately gelled into an alkyd resin product, the gelation process can occur almost instantaneously, saving manufacturing and processing time of the alkyd resin, and significantly reducing the amount of by-products that form.

In another aspect, the invention relates to a method for preparing a liquid alkyd resin precursor. In this method, a gel point modifier is added to a prepolymer liquid that has reached about 50% to about 90%, preferably about 80% to about 85% of its theoretical gel point to form the liquid alkyd resin precursor. In some embodiments, a small amount of water is added to the liquid alkyd resin precursor prevent the onset of premature gelation.

The prepolymer liquid of the alkyd resin precursor includes a polyol, an excipient selected from the group consisting of a polyfunctional acid, an anhydride, and mixtures thereof, and oligomers formed by the condensation of the polyol with the excipient. When the excipient is a polyfunctional acid, the molar ratio of total acid moieties on the polyfunctional acid to alcohol moieties on the polyol preferably is about 10:1 to about 1:10, more preferably about 3:1 to about 1:3, and even more preferably about 1:1. When the excipient is an anhydride, the molar ratio of total anhydride moieties on the anhydride to total alcohol moieties on the polyol preferably is about 5:1 to about 1:5, preferably about 1.5:1 to about 1:1.5, even more preferably about 0.5:1.

The gel point modifier in this aspect of the invention is a molecule that includes at least three, preferably at least four functional groups selected from the group consisting of acids, alcohols, amines, thiols, and mixtures thereof, as described herein. The gel point modifier can be an alcohol having primary hydroxyl groups or a polyfunctional acid, the alcohol or acid having at least four functional groups. The gel point modifier can also be a derivatized fatty acid, fat, or oil. Nonlimiting examples of the gel point modifier are described herein. The gel point modifier is preferably present in a concentration of about 0.1 wt. % to about 10 wt. %, more preferably about 0.5 wt. % to about 5 wt. %, even more preferably about 1 wt. %, based on the total weight of the precursor.

The corrected, theoretical gel point in this aspect of the invention is determined by Formula II, as described above.

This method allows, for the first time, the formation of a novel, metastable, alkyd material that has exceeded its gel point, but is not a gel. As previously described herein, this alkyd resin precursor can be stored and shipped at temperatures of up to about 100° C. This material can subsequently be gelled at will into a fully cross-linked alkyd resin with good dimensional stability and mechanical integrity by heating the liquid alkyd resin precursor to promote further condensation while removing the water by-product.

One way the prepolymer liquid in this aspect of the invention can be obtained is as described below. A mixture is prepared that includes a polyol and an excipient selected from the group consisting of a polyfunctional acid, an anhydride, and mixtures thereof. This mixture is heated to a temperature sufficient to promote condensation of the polyol with the excipient, while concurrently removing water that forms as a by-product. Condensation is arrested when about 40% to about 80%, preferably about 70% to about 75%, of the polyol and excipient have been converted to oligomer, but before the gel point of the material is reached. The resulting prepolymer liquid includes the polyol, the excipient, and oligomers formed by the condensation of the polyol with the excipient, and has reached at about 50% to about 90%, preferably about 80% to about 85%, of its corrected, theoretical gel point, as determined by Formula II, described above.

In this embodiment of the invention, the condensation reaction is arrested before the gel point of the material is reached. The progress of the reaction can be determined by, for example, monitoring the viscosity of the prepolymer liquid, calculating the amount of water that should theoretically form as a by-product of the reaction and then discontinuing the reaction when the determined amount of water has been collected, and by monitoring the number of free alcohol and acid moieties that are present in the reaction solution.

The condensation reaction can be arrested by any method typically used to arrest condensation reactions. In one embodiment, the condensation reaction can be arrested by cooling the prepolymer liquid to a temperature less than the temperature sufficient to promote condensation. In another embodiment, the condensation reaction can be arrested by discontinuing the removal of the water by-product. Discontinuing the removal of water effectively arrests the condensation reaction because ester condensation is in equilibrium with ester hydrolysis as shown below. Ester condensation is triggered and driven by the removal of water while ester hydrolysis is triggered and driven by the addition of water.

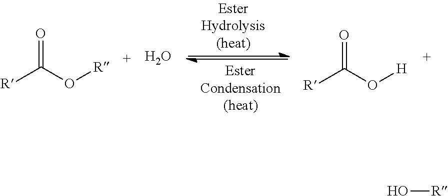

The mixture of the polyol and the excipient in this embodiment can be heated to a temperature that promotes condensation of the polyol with the excipient. In some embodiments, the mixture can be heated to a temperature of about 100° C. to about 300° C., preferably about 160° C. to about 220° C.

The polyol preferably is a molecule that includes at least two alcohol moieties, more preferably at least three alcohol moieties, as previously described herein. Preferably, the alcohol moieties are primary hydroxyl groups. The polyol preferably is added to the mixture in an amount of about 10 wt. % to about 90 wt. %, more preferably about 20 wt. % to about 80 wt. %, and still more preferably about 30 wt. % to about 70 wt. %, based on the total weight of components in the mixture.

The excipient is selected from the group consisting of a polyfunctional acid, an anhydride, and mixtures thereof. The polyfunctional acid preferably is a molecule that includes at least two carboxylic acid moieties, more preferably at least three carboxylic acid moieties, as previously described herein. The anhydride preferably is a molecule that includes at least one anhydride moiety, as previously described herein. The excipient preferably is added to the mixture in an amount of about 10 wt. % to about 90 wt. %, more preferably about 20 wt. % to about 80 wt. %, and still more preferably about 30 wt. % to about 70 wt. %, based on the total weight of components in the mixture.

When the oligomers of the prepolymer liquid are the result of the condensation between a polyfunctional acid and polyol, the molar ratio of total acid moieties on the polyfunctional acid to alcohol moieties on the polyol is preferably about 10:1 to about 1:10, more preferably about 3:1 to about 1:3, and even more preferably about 1:1. When the oligomers of the prepolymer liquid are the result of the condensation between an anhydride and a polyol, the molar ratio of total anhydride moieties on the anhydride to total alcohol moieties on the polyol preferably is about 5:1 to about 1:5, more preferably about 1.5:1 to about 1:1.5, and even more preferably about 0.5:1.

In another aspect, the invention relates to a method of preparing a fully cross-linked alkyd resin. In this method, a gel point modifier is added to a prepolymer liquid that has reached at least about 50% to about 90%, preferably about 80% to about 85% of its corrected, theoretical gel point to form the liquid alkyd resin precursor. The precursor is then gelled into a fully cross-linked alkyd resin of any desired shape by heating the precursor to a temperature sufficient to promote condensation while concurrently removing the water by-product.

The prepolymer liquid includes a polyol, an excipient selected from the group consisting of a polyfunctional acid, an anhydride, and mixtures thereof, and oligomers that were formed by the condensation of the polyol with the excipient. When the excipient is a polyfunctional acid, the molar ratio of total acid moieties on the polyfunctional acid to alcohol moieties on the polyol preferably is about 10:1 to about 1:10, more preferably about 3:1 to about 1:3, and even more preferably about 1:1. When the excipient is an anhydride, the molar ratio of total anhydride moieties on the anhydride to total alcohol moieties on the polyol preferably is about 5:1 to about 1:5, more preferably about 1.5:1 to about 1:1.5, even more preferably about 0.5:1.

The gel point modifier of this aspect of the invention is a molecule that comprises at least three, preferably at least four functional groups selected from the group consisting of acids, alcohols, amines, thiols, and mixtures thereof, as described herein. The gel point modifier can be an alcohol having primary hydroxyl groups or polyfunctional acid, the alcohol or acid comprising at least four functional groups. The gel point modifier can also be a derivatized fatty acid, fat or oil. Nonlimiting examples of the gel point modifier are described herein. The gel point modifier is preferably present in a concentration as described herein. The gel point modifier is preferably present in a concentration of about 0.1 wt. % to about 10 wt. %, more preferably about 0.5 wt. % to about 5 wt. %, even more preferably about 1 wt. %, based on the total weight of the precursor.

According to this aspect of the invention, the alkyd resin precursor can be heated to a temperature that promotes condensation. In some embodiments, the precursor can be heated to a temperature of about 100° C. to about 300° C., more preferably about 160° C. to about 220° C.

The method described herein to form fully cross-linked alkyd resins takes advantage of the strong influence of the number of individual monomer functional groups on the gel point of the material by: (i) carrying out the alkyd condensation reaction in the absence of a highly functional compound to drive the condensation reaction to a high degree of conversion, (ii) introducing a small amount of a highly functional molecule that can effectively shift the gel point to a low value, which is below the extent of condensation already achieved to form a stable, alkyd resin precursor, (iii) inducing an almost instantaneous gelation of the precursor to solidify the reaction mixture into a desired shape of good dimensional integrity, and (iv) completing the fabrication of a fully cross-linked alkyd resin article with properties characteristic of a thermoset resin by further curing the solidified gel.

The ability to solidify the alkyd resin precursor into a prescribed shape before the fabrication of the final product is advantageous because it reduces the requirement of a long residence time in a forming operation, such as, for example, molding and fiber spinning Furthermore, undesirable effects associated with the curing of a fluid, such as the formation of bubbles and other defects in the final product due to the liberation of water vapor during condensation, is significantly reduced by carrying out the final curing process on a rigid, solid gel instead of on a fluid.

This method is also advantageous because it allows control and predictability over the onset of gelation. As previously described, two approaches currently exist for the formation of alkyd materials. In the first approach, condensation of monomers is allowed to occur up to the gel point of the material, at which point the condensation reaction is arrested. In the second approach, the condensation of monomers is allowed to occur until the prepolymer material has exceeded its gel point to form a solid, cross-linked network. Often, the onset of gelation is difficult to predict or control, which makes the processing of these materials difficult. The higher the number of functional groups on the monomers, the more difficult it is to control the onset of gelation.

It has now been found that control over the onset of gelation can quite surprisingly be obtained by adding a gel point modifier to an alkyd prepolymer liquid, even though the gel point modifier is itself highly functionalized. The addition of a gel point modifier to a prepolymer solution wherein further condensation has been arrested, affords a metastable, liquid alkyd material. This alkyd material is metastable because it has technically exceeded its gel point but is not a gel. When gelation is desired, the metastable material is subjected to the addition of heat and the removal of water to trigger almost immediate gelation. Therefore, the metastable material allows a significant amount of control over the onset of gelation of a fully cross-linked alkyd resin.

### EXAMPLES

The following examples are provided to illustrate the invention, but are not intended to limit the scope thereof. The experiment described in Example 1 demonstrates the formation of a glycerol-maleate cross-linked alkyd resin, not according to the invention, without the use of a gel point modifier. The experiment described in Example 2 demonstrates the formation of a glycerol-maleate cross-linked alkyd resin, according to the invention, with the use of a gel point modifier.

### Example 1

In this example, a glycerol-maleate cross-linked resin is prepared without a gel point modifier. Glycerol (101.30 g, 1.1 mol; Superol, P&G Chemicals), methanesulfonic acid (0.52 g, 0.25 wt %, Aldrich) and a stir bar were added to a beaker. The mixture was warmed to about 60° C. while stirring moderately. Maleic anhydride (107.87 g, 1.1 mol; Acros) was slowly added to the warming/stirring glycerol solution until all of the material had been added. Addition of the maleic anhydride continued as it melted and dispersed. The temperature was slowly raised to 150° C. while the viscosity and temperature of the solution was monitored with a viscometer (Brookfield) and thermometer. Heating and stirring continued at 150° C. until the material viscosity was high enough to prevent the stir bar from spinning. The total reaction time was about 47 min.

### Example 2

In this example, a glycerol-maleate cross-linked resin is prepared with a gel point modifier. Glycerol (101.30 g, 1.1 mol; Superol, P&G Chemicals), methanesulfonic acid (0.52 g, 0.25 wt %, Aldrich) and a stir bar were added to a beaker. The mixture was warmed to about 60° C. while stirring moderately. Maleic anhydride (107.87 g, 1.1 mol; Acros) was slowly added to the warming/stirring glycerol solution until all the material had been added. The temperature was slowly raised to 150° C. while the viscosity and temperature of the solution was monitored with a viscometer (Brookfield) and thermometer. After 15 min at 150° C., pentaerythritol (10.46 g, 5 wt %, Aldrich) was added to the solution while maintaining a constant temperature and stir rate. Heating and stirring continued at 150° C. until the material viscosity was high enough to prevent the stir bar from spinning. The total reaction time was about 38 min.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid alkyd resin precursor comprising:
(a) a gel point modifier; and
(b) prepolymer liquid comprising oligomeric polyesters, polyols, and an excipient selected from the group consisting of polyfunctional acids, anhydrides, and mixtures thereof; the prepolymer liquid having reached about 50% to about 90% of its corrected, theoretical gel point, p_{gel(corrected)}, as determined by Formula II:
$${p}_{gel ( corrected )} = \frac{2 ( k )}{{f}_{average}} \qquad Formula II$$
wherein k is about 0.9 to about 1, and f_{average} is the sum of (i) the number of alcohol moieties on the polyol, (ii) the number of acid moieties on the polyfunctional acid, and (iii) twice the number of anhydride moieties on the anhydride, divided by the total number of polyols, polyfunctional acids, and anhydrides.

2. The liquid alkyd resin precursor of claim 1, wherein the prepolymer liquid is at about 80% to about 85% of its theoretical gel point.

3. The liquid alkyd resin precursor of claim 1, wherein k is about 0.95.

4. The liquid alkyd resin precursor of claim 1 having a viscosity of about 0.1 kg m⁻¹s⁻¹to about 10,000 kg m⁻¹s⁻¹ at about 160° C. to about 220° C.

5. The liquid alkyd resin precursor of claim 1, wherein the polyol is selected from the group consisting of glycerol, 1,3-propanediol, pentaerythritol, dipentaerythritol, trimethylolpropane, trimethylolethane, ethylene glycol, diethylene glycol, polyglycerol, diglycerol, triglycerol, 1,2-propanediol, 1,4-butanediol, neopentylglycol, hexanediol, hexanetriol, erythritol, xylitol, maltitol, mannitol, polyvinyl alcohol, and mixtures thereof.

6. The liquid alkyd resin precursor of claim 5, wherein the polyol is selected from the group consisting of glycerol, pentaerythritol, trimethylolpropane, trimethylolethane, and mixtures thereof.

7. The liquid alkyd resin precursor of claim 1, wherein the excipient is selected from the group consisting of adipic acid, maleic acid, succinic acid, sebacic acid, suberic acid, fumaric acid, glutaric acid, phthalic acid, malonic acid, isophthalic acid, terephthalic acid, azelaic acid, dimethylolpropionic acid, maleic anhydride, succinic anhydride, phthalic anhydride, trimellitic anhydride, polyacrylic acid, polymethacrylic acid, and mixtures thereof.

8. The liquid alkyd resin precursor of claim 6, wherein the excipient is an anhydride selected from the group consisting of maleic anhydride, succinic anhydride, phthalic anhydride, and mixtures thereof.

9. The liquid alkyd resin precursor of claim 1, wherein the molar ratio of total acid moieties on the polyfunctional acid to total alcohol moieties on the polyol is about 10:1 to about 1:10.

10. The liquid alkyd resin precursor of claim 9, wherein the molar ratio is about 3:1 to about 1:3.

11. The liquid alkyd resin precursor of claim 10, wherein the molar ratio is about 1:1.

12. The liquid alkyd resin precursor of claim 1, wherein the molar ratio of total anhydride moieties on the anhydride to total alcohol moieties on the polyol is about 5:1 to about 1:5.

13. The liquid alkyd resin precursor of claim 12, wherein the molar ratio is about 1.5:1 to about 1:1.5.

14. The liquid alkyd resin precursor of claim 13, wherein the molar ratio is about 0.5:1.

15. The liquid alkyd resin precursor of claim 1, wherein the gel point modifier comprises at least three functional groups selected from the group consisting of acids, alcohols, amines, thiols, epoxides, anhydrides, and mixtures thereof.

16. The liquid alkyd resin precursor of claim 15, wherein the gel point modifier is selected from the group consisting of glycerol, pentaerythritol, dipentaerythritol, trimethylolpropane, trimethylolethane, polyglycerol, diglycerol, triglycerol, hexanetriol, erythritol, xylitol, maltitol, mannitol, polyvinyl alcohol, succinic acid, trimellitic anhydride, polyacrylic acid, polymethacrylic acid, and mixtures thereof.

17. The liquid alkyd resin precursor of claim 16, wherein the gel point modifier is selected from the group consisting of pentaerythritol, trimethylolpropane, trimethylolethane, polyacrylic acid, and mixtures thereof.

18. The liquid alkyd resin precursor of claim 15, wherein the gel point modifier is selected from the group consisting of derivatized tall oil, corn oil, soybean oil, sunflower oil, safflower oil, linseed oil, perilla oil, cotton seed oil, tung oil, peanut oil, oiticica oil, hempseed oil, marine oil, dehydrated castor oil, and mixtures thereof.

19. The liquid alkyd resin precursor of claim 1, wherein the gel point modifier is present in an amount of about 0.1 wt. % to about 10 wt. %, based on the total weight of the precursor.

20. The liquid alkyd resin precursor of claim 17, wherein the gel point modifier is present in an amount of about 0.5 wt. % to about 5 wt. %, based on the total weight of the precursor.

21. The liquid alkyd resin precursor of claim 20, wherein the gel point modifier is present in an amount of about 1 wt. %, based on the total weight of the precursor.

22. A method of preparing a liquid alkyd resin precursor, the method comprising adding a gel point modifier to a prepolymer liquid to form the liquid, alkyd resin precursor, wherein the prepolymer liquid comprises oligomeric polyesters, polyols, and an excipient selected from the group consisting of polyfunctional acids, anhydrides, and mixtures thereof; the prepolymer liquid having reached about 50% to about 90% of its corrected, theoretical gel point p_{gel(corrected)}.

23. The method of claim 22, wherein the gel point modifier comprises at least three functional groups selected from the group consisting of acids, alcohols, amines, thiols, epoxides, anhydrides, and mixtures thereof.

24. The method of claim 23, wherein the gel point modifier is selected from the group consisting of glycerol, pentaerythritol, dipentaerythritol, trimethylolpropane, trimethylolethane, polyglycerol, diglycerol, triglycerol, hexanetriol, erythritol, xylitol, maltitol, mannitol, polyvinyl alcohol, succinic acid, trimellitic anhydride, polyacrylic acid, polymethacrylic acid, and mixtures thereof.

25. The method of claim 24, wherein the gel point modifier is selected from the group consisting of pentaerythritol, trimethylolpropane, trimethylolethane, polyacrylic acid, and mixtures thereof.

26. The liquid alkyd resin precursor of claim 23, wherein the gel point modifier is selected from the group consisting of derivatized tall oil, corn oil, soybean oil, sunflower oil, safflower oil, linseed oil, perilla oil, cotton seed oil, tung oil, peanut oil, oiticica oil, hempseed oil, marine oil, dehydrated castor oil, and mixtures thereof.

27. The method of claim 22, wherein the gel point modifier is added in an amount of about 0.1 wt % to about 10 wt %, based on the total weight of the precursor.

28. The method of claim 27, wherein the gel point modifier is added in an amount of about 0.5 wt. % to about 5 wt. %, based on the total weight of the precursor.

29. The method of claim 28, wherein the gel point modifier is added in an amount of about 1 wt %, based on the total weight of the precursor.

30. A method of preparing fully cross-linked alkyd resin, the method comprising:
(a) adding a gel point modifier to a prepolymer liquid to form a liquid, alkyd resin precursor; and,
(b) heating the alkyd resin precursor to a temperature sufficient to promote further condensation, while concurrently removing water formed during condensation to form fully cross-linked alkyd resin,
wherein the prepolymer liquid in step (a) comprises oligomeric polyesters, polyols, and an excipient selected from the group consisting of polyfunctional acids, anhydrides, and mixtures thereof; the prepolymer liquid having reached about 50% to about 90% of its corrected, theoretical gel point p_{gel(corrected)}.

31. The method of claim 22 or 30, wherein the corrected, theoretical gel point, p_{gel(corrected)}, is determined by Formula II:
$${p}_{gel ( corrected )} = \frac{2 ( k )}{{f}_{average}} \qquad Formula II$$
wherein k is about 0.9 to about 1, and f_{average} is the sum of (i) the number of alcohol moieties on the polyol, (ii) the number of acid moieties on the polyfunctional acid, and (iii) twice the number of anhydride moieties on the anhydride, divided by the total number of polyols, polyfunctional acids, and anhydrides.
